(19) United States
(12) Patent Application Publication
(10) Pub. No.: US 2012/0085602 A1
(43) Pub. Date: Apr. 12, 2012

(54) Braking Device of a Golf Bag Cart

(76) Inventor: Gordon Liao, Yung Kang City (TW)

(21) Appl. No.: 12/899,675

(22) Filed: Oct. 7, 2010

(51) Int. Cl. F16D 65/00

(52) U.S. Cl. 188/167

(57) ABSTRACT

A braking device of a golf bag cart includes a fixing member, a compression spring and a curved tube. The fixing member is connected with a connecting plate of a swing-arm of the golf bag cart, having a chamber formed in one side. The compression spring is installed in the chamber of the fixing member. The curved tube is formed nearly L-shaped, with a horizontal portion fitted in the chamber of the fixing member so as to enable the curved tube to rotate freely against the fixing member, and has a vertical portion used to let a braking wire extend out. With the curved tube to rotate freely, the braking wire can be protected from improperly bent or squeezed to get broken while folding or unfolding the golf bag cart.

### BACKGROUND OF THE INVENTION

1. Field of the Invention

This invention relates to a braking device of a golf bag cart, particularly to one able to keep a braking wire from being improperly curved or squeezed to break.

2. Description of the Prior Art

Commonly, as shown in FIGS. 1 and 2, a conventional brake device 1 of a golf bag cart is composed of a fixing member 11, a bolt 12 and a compression spring 13. The fixing member 11 is connected with a connecting plate 10 of a swing-arm so as to enable a rear wheel halted from running. The bolt 12 is threadably connected with the fixing member 11, with the compression spring 13 inserted in the fixing member 11. A braking wire 14 is extended out of one end of the bolt 12, apt to be forcefully squeezed or improperly curved to get damaged by external force. That is, the braking wire 14 can be not only easily compressed by a front wheel moved to a bottom of the golf bag cart, but also improperly bent while folding the golf bag cart, apt to be broken rapidly.

### SUMMARY OF THE INVENTION

The object of this invention is to offer a braking device of a golf bag cart, able to protect a braking wire from being bent or squeezed improperly.

The main characteristics of the invention are a fixing member, a compression spring and a curved tube. The fixing member is connected with a connecting plate of a swing-arm of the golf bag cart, having a chamber formed in one side. The compression spring is installed in the chamber of the fixing member. The curved tube is formed nearly L-shaped, with a horizontal portion fitted in the chamber of the fixing member so as to enable the curved tube to rotate freely against the fixing member, and has a vertical portion used to let a braking wire extend out. With the curved tube to rotate freely, the braking wire can be protected from improperly bent or squeezed to get broken while folding or unfolding the golf bag cart.

### BRIEF DESCRIPTION OF DRAWINGS

This invention is better understood by referring to the accompanying drawings, wherein:

FIG. 1 is a perspective view of a conventional brake device for a golf bag cart;

FIG. 2 is an exploded perspective view of the conventional brake device for a golf bag cart;

FIG. 3 is a perspective view of a preferred embodiment of a brake device of a golf bag cart in the present invention;

FIG. 4 is an exploded perspective view of the preferred embodiment of a brake device of a golf bag cart in the present invention;

FIG. 5 is a cross-sectional view of the preferred embodiment of a brake device of a golf bag cart in the present invention;

FIG. 6 is a perspective view of the preferred embodiment of a brake device of a golf bag cart in the present invention, showing it being installed on the golf bag cart;

FIG. 7 is a perspective view of the invention installed on a golf bag cart, showing the golf bag cart is being folded up; and

FIG. 8 is a perspective view of the invention installed on a golf bag cart, showing the golf bag cart has been completely folded up.

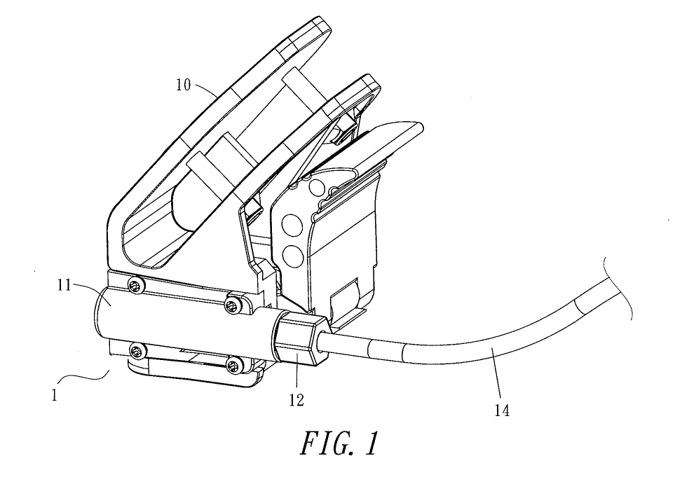

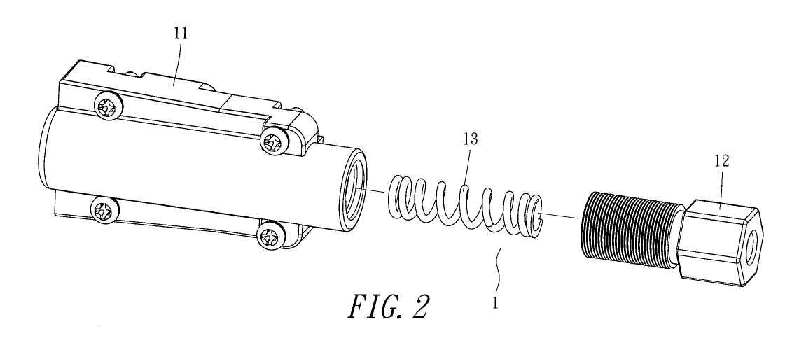

### DETAILED DESCRIPTION OF THE PREFERRED EMBODIMENT

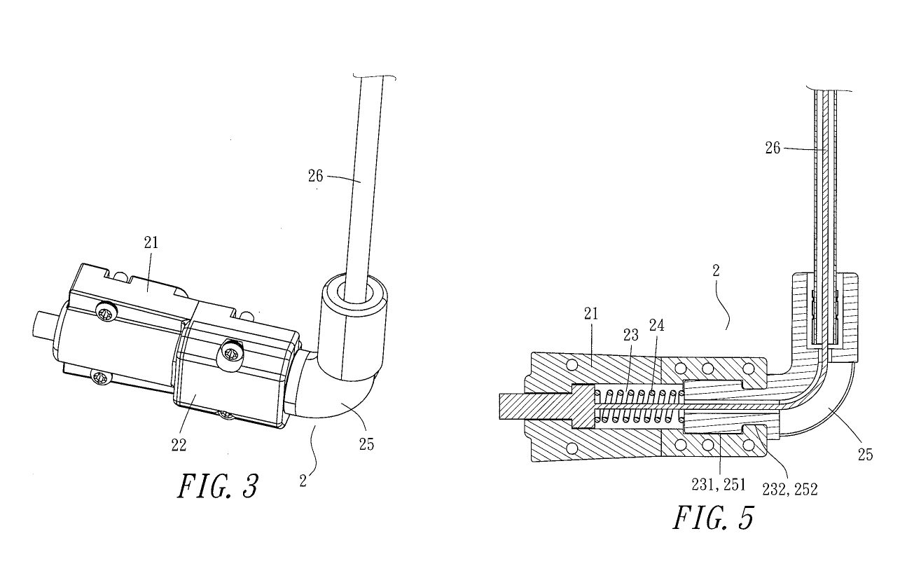

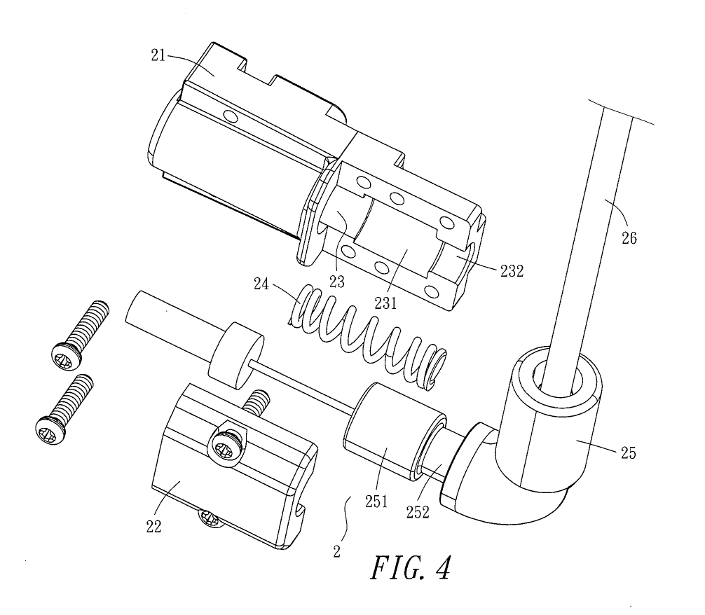

As shown in FIGS. 3˜6, a preferred embodiment of a braking device 2 of a golf bag cart in the present invention includes a fixing member 21, a compression spring 24 and a curved tube 25.

The fixing member 21 is connected with a connecting plate 30 of a swing-arm of the golf bag cart, with one side threadably combined with a fixing lid 22 so that the interior of the fixing member 21 is defined as a cylindrical chamber 23 divided into a large space 231 with a comparatively larger diameter and a small space 232 with a comparatively smaller diameter.

The compression spring 24 is installed in the chamber 23 of the fixing member 21.

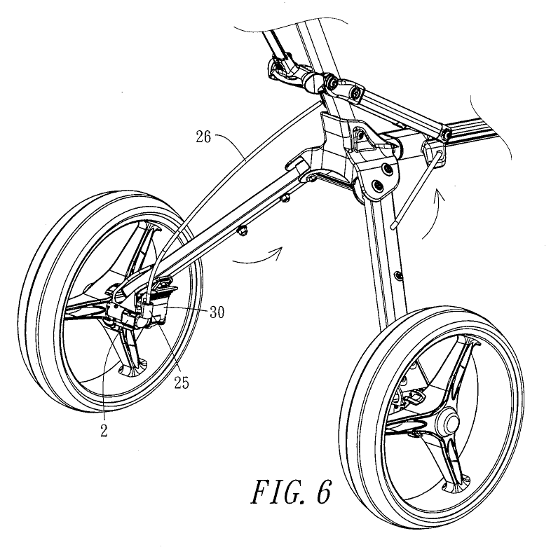

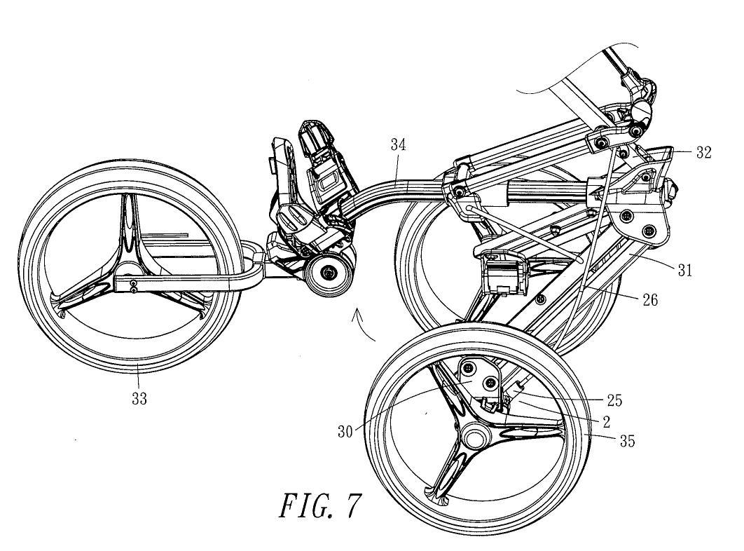

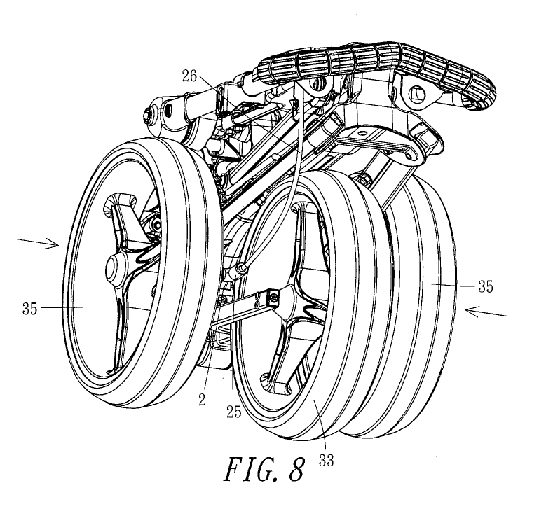

The curved tube 25 is formed nearly L-shaped, with a horizontal portion having a cylinder 251 with a comparatively larger diameter and a neck 252 with a comparatively smaller diameter, respectively fitted in the large space 231 and the small space 232 of the chamber 23. Meanwhile, the compression spring 24 is confined in the chamber 23 of the fixing member 21, kept in place by the free end of the cylinder 251 so that the curved tube 25 can freely rotate against the fixing member 21. So a braking wire 26 can be extended out of a vertical free end of the curved tube 25, and rotate freely for 360 degrees in any direction. In using, as shown in FIG. 6, when the golf bag cart is unfolded, the curved tube 25 is moved to head upward. On the contrary, as shown in FIGS. 6˜8, when the golf bag cart is to be folded up, each foot 31 of rear wheels 35 is first turned to move forward and inward, with the connecting plate 30 of the swing-arm correspondingly rotated to enable the braking wire 26 to move over the feet 31 of the rear wheels to an upper bag rack 32. Next, the curved tube 25 can be turned to move backward without pushing the braking wire 26. Therefore the braking wire 26 can smoothly extend down from the upper bag rack 32, with the curved portion freed from being forcefully bent. Finally, a front wheel 33 is turned to stay under a lower bag rack 34. During the folding process, by means of stress of the braking wire 26 to drive the curved tube 25 to rotate, the braking wire 26 can be kept from being squeezed intensely. Moreover, although it is inevitable that two rear wheels 35 would move inwards to approach the braking wire 26 and squeeze it after being completely folded, the curved portion of the braking wire 26 can be protected from being improperly bent or squeezed because the curved tube 25 is able to rotate freely.

So, as the curved tube 25 can freely rotate against the fixing member 21 like an universal joint, the braking wire 26 can be protected from being improperly bent or squeezed while folding or unfolding the golf bag cart, ensuring strands of the braking wire 26 from fractured.

The advantages of the invention are described as can be seen from the foresaid description.

While the preferred embodiment of the invention has been described above, it will be recognized and understood that various modifications may be made therein and the appended claims are intended to cover all such modifications that may fall within the spirit and scope of the invention.

What is claimed is:

1. A braking device of a golf bag cart comprising:
a fixing member connected with a connecting plate of a swing-arm of said golf bag cart and having a chamber formed in one side;
a compression spring installed in said chamber of said fixing member; and
a curved tube similarly formed L-shaped and provided with a horizontal portion fitted in said chamber of said fixing member, said curved tube able to freely rotate against said fixing member, said curved tube having a vertical portion employed to let a braking wire extend out.

2. The braking device of a golf bag cart as claimed in claim 1, wherein said fixing member includes a fixing lid threadably combined at one side.

3. The braking device of a golf bag cart as claimed in claim 1, wherein said chamber of said fixing member is divided into a large space with a comparatively larger diameter and a small space with a comparatively smaller diameter, and said horizontal portion of said curved tube is provided with a cylinder having a comparatively larger diameter and a neck having a comparatively smaller diameter.
